(19) United States
(12) Patent Application Publication
(10) Pub. No.: US 2011/0235673 A1
(43) Pub. Date: Sep. 29, 2011

(54) ANALYSIS APPARATUS, ANALYSIS METHOD AND ANALYSIS PROGRAM

(75) Inventors: Daisuke Mizutani, Kawasaki (JP); Nobutaka Ito, Kawasaki (JP)

(73) Assignee: FUJITSU LIMITED, Kawasaki-shi (JP)

(21) Appl. No.: 13/156,151

(22) Filed: Jun. 8, 2011

Related U.S. Application Data
(63) Continuation of application No. PCT/JP2008/072304, filed on Dec. 9, 2008.

(51) Int. Cl. G01N 25/16

(52) U.S. Cl. 374/55; 374/E05.001

(57) ABSTRACT

A first generating part assumes that a circuit board is a laminated body of a lower layer portion and an upper layer portion and sets a thermal expansion coefficient of the circuit board itself having been actually measured in advance as a thermal expansion coefficient α₁ of the lower layer portion. Further, the first generating portion sets a value obtained by a Stoney's equation as a thermal expansion coefficient α₂ of the upper layer portion. Then, the laminated body of the lower layer portion and the upper layer portion is segmented into a plurality of grid data and element segment data in which a position and a material of grid data are made to correspond to each other is generated. The second calculating part calculates a physical amount occurring in an analysis object based on a finite element with a variety of solvers, and outputs an analysis result. In other words, the second calculating part performs a simulation of behavior of the analysis object. This simulation is in an arbitrary temperature range set by a user.

### CROSS-REFERENCE TO RELATED APPLICATION

This application is a Continuation of International Application No. PCT/JP2008/072304, with an international filing date of Dec. 9, 2008, which designating the United States of America, the entire contents of which are incorporated herein by reference.

### FIELD

The present embodiment relates to an analysis apparatus, an analysis method, and an analysis program.

### BACKGROUND

A circuit board, in which an integrated circuit pattern is formed on a substrate with a mask technique, is used in a mother board or the like of an electronic apparatus.

However, in a reflow process, in which an electronic component (for example, LSI: Large Scale integration) is mounted to a circuit board, a warpage might occur in the circuit board depending on a temperature condition of the reflow process. Such a warpage brings about unadherence, a short circuit, and so on in a bump joining portion or the like of the electronic component, reducing a yield of a product.

Thus, there is considered a technique to perform a structural analysis of a circuit board by combining a CAD (Computer Aided Design) system and a finite element method thereby to predict a warpage occurring in the circuit board as described above in advance. According to such conventional techniques, it is possible to change design to a circuit board in which a warpage occurs less frequently in a mounting process by prediction.

The related arts are disclosed in, e.g., Reference 1 (Japanese Laid-open Patent Publication No. 2004-13437), Reference 2 (Japanese Laid-open Patent Publication No. 10-93206), and Reference 3 (Japanese Laid-open Patent Publication No. 2000-231579).

### SUMMARY

According to an aspect of an embodiment, an analysis apparatus includes an assuming portion configured to assume that a structure of a circuit board includes two substances with thermal expansion coefficients different from each other; and a simulation portion configured to simulate a mounting stress in mounting an electronic component to the circuit board with a result of an assumption by the assuming portion.

According to another aspect of an embodiment, an analysis method includes assuming that a structure of a circuit board includes two substances with thermal expansion coefficients different from each other; and simulating a mounting stress in mounting an electronic component to the circuit board with a result of an assumption in the assuming.

According to a further aspect, an analysis program product for causing a computer to perform includes assuming that a structure of a circuit board includes two substances with thermal expansion coefficients different from each other; and simulating a mounting stress in mounting an electronic component to the circuit board with a result of an assumption in the assuming.

### BRIEF DESCRIPTION OF DRAWINGS

FIG. 1A is a top view illustrating an example of an analysis object of an analysis apparatus according to an embodiment;

FIG. 1B is a cross-sectional view taken along a line I-I in FIG. 1A;

FIG. 1C is a cross-sectional view illustrating a deformation of the analysis object due to a heating;

FIG. 2A is a diagram illustrating a content of an assumption of a structure of a circuit board 1;

FIG. 2B is a diagram illustrating a warpage of the circuit board 1 under the assumption illustrated in FIG. 2A;

FIG. 3 is a block diagram illustrating a configuration of an analysis apparatus according to an embodiment;

FIG. 4 is a table illustrating an example of a data configuration of a material physical property table 332;

FIG. 5 is a table illustrating an example of a data configuration of a thickness table 333;

FIG. 6 is a functional block diagram illustrating a configuration of an analysis apparatus 30;

FIG. 7 is a flowchart illustrating an operation of the analysis apparatus 30;

FIG. 8 is a flowchart illustrating a method for generating laminated shell data 336;

FIG. 9 is a table illustrating an example of a data configuration of the laminated shell data 336;

FIG. 10A is a plan view illustrating an analysis object;

FIG. 10B is a cross-sectional view taken along a line II-II in FIG. 10A; and

FIG. 11 is a graph illustrating a result of an analysis (simulation) actually performed.

### DESCRIPTION OF EMBODIMENTS

Only by the conventional techniques, though the warpage of the circuit board itself may be predicted, a stress acting on a bump used in mounting and a distortion due thereto may not be predicted.

Besides, if a simulation is performed based on a model in which an electronic component and a bump are integrated in a circuit board, a calculation amount is quite large and an analysis time is prolonged, so that a load to the CAD system becomes significantly large. Further, since a prediction with a sufficient accuracy is impossible even by the above-described conventional technique and thus a warpage of a circuit board occurring in the mounting process may not be suppressed enough, an error is enlarged when the model as described above is used, and it becomes quite difficult to perform a prediction at a high accuracy.

The present inventor has conducted studies in order to find out a problem of the conventional technique, and has found out that, though an actual measurement of a three-dimensional deformation corresponding to a temperature change of a circuit board itself is possible, a result of such an actual measurement is not reflected in a numeric analysis in the conventional technique. If the result of the actual measurement may be reflected in a prediction of a warpage, a highly accurate predication becomes able to be performed. However, it is not easy to incorporate a deformation corresponding to a temperature change into an analysis by a finite element method.

Thus, as a result of further studies conducted by the present inventor, it is found out that a prediction of a deformation corresponding to a temperature change is possible if an analysis is performed on an assumption that a circuit board is constituted by a plurality of substances with different thermal expansion coefficients or the like, even if it is assumed that a structure is simple. The present inventor has reached the following aspects of the embodiment based on the above observation.

An analysis apparatus is provided with an assuming portion assuming that a structure of a circuit board includes two substances with thermal expansion coefficients different from each other. Further, the analysis apparatus is provided with a simulation portion which simulates a mounting stress in mounting an electronic component to the circuit board with a result of an assumption by the assuming portion.

In an analysis method, it is assumed that a structure of a circuit board includes two substances with thermal expansion coefficients different from each other, and thereafter, a mounting stress in mounting an electronic component to the circuit board is simulated with a result of an assumption in the assuming.

An analysis program product causes a computer to perform: assuming that a structure of a circuit board includes two substances with thermal expansion coefficients different from each other; and simulating a mounting stress in mounting an electronic component to the circuit board with a result of an assumption in the assuming.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

Hereinafter, embodiments will be described specifically with reference to the attached drawings. An analysis apparatus according to the embodiment is an apparatus which performs an analysis of a deformation of a circuit board due to a temperature change and the like. In other words, an object (analysis object) of a structural analysis by the analysis apparatus is a circuit board and the like.

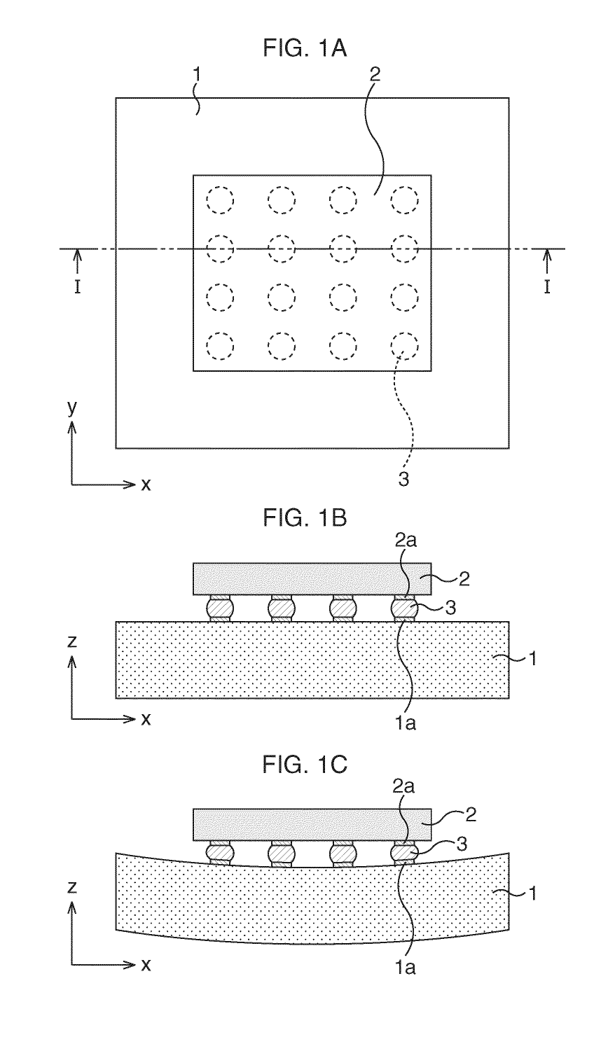

First, the analysis object is described. FIG. 1A to FIG. 1C are diagrams illustrating an example of the analysis object of the analysis apparatus according to the embodiment. FIG. 1A is a top view illustrating the analysis object, and FIG. 1B is a cross-sectional view taken along a line I-I in FIG. 1A. Further, FIG. 1C is a cross-sectional view illustrating a deformation of the analysis object due to a heating.

In this example, the analysis object includes a circuit board 1 and an electronic component 2 to be mounted thereto via a solder bump 3. An electrode 1a is provided in one surface of the circuit board 1, an electrode 2a is provided in one surface of the electronic component 2, and the electrode 1a and the electrode 2a are connected via the solder bump 3. In mounting the electronic component 2, a reflow is performed. In other words, a temperature of the circuit board 1 rises and thereafter falls. At a time of the reflow, as illustrated in FIG. 1C, a warpage occurs in the circuit board 1. Thereafter, when the temperature of the circuit board 1 falls, the circuit board 1 tends to return to a flat state. On this occasion, since the solder bump 3 is already fixed to the electrode 1a and the electrode 2a, a stress acts on the solder bump 3, generating a distortion.

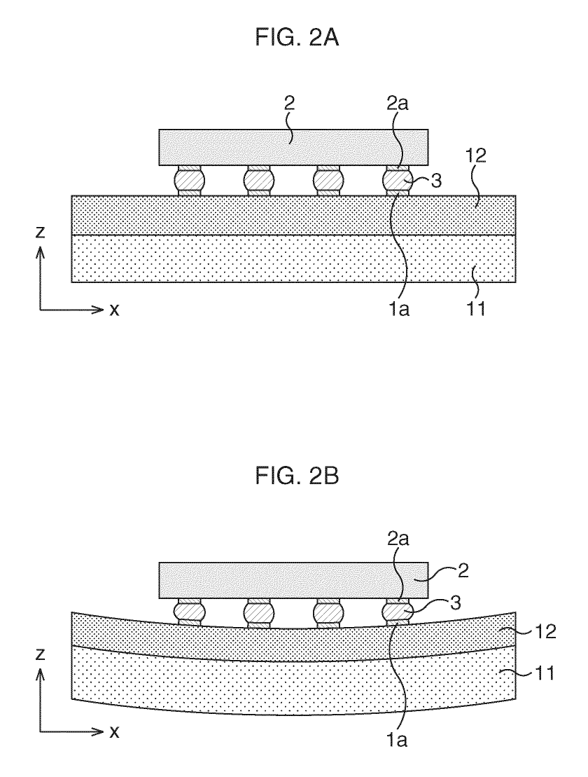

In the present embodiment, in order to predict the stress and the distortion due to a deformation of the circuit board 1 as described above, a simulation is performed on an assumption that a circuit board 1 is constituted by a lower layer portion 11 and an upper layer portion 12 which have different thermal expansion coefficients as illustrated in FIG. 2A. When the circuit board 1 is heated under such an assumption, the circuit board 1 warps as illustrated in FIG. 2B. A degree of such a warpage may be matched to an actual measured value of a warpage amount of the circuit board 1 by setting thicknesses and the thermal expansion coefficients of the lower layer portion 11 and the upper layer portion 12 properly in advance.

Further, it is possible to regard a laminated body of the lower layer portion 11 and the upper layer portion 12 as a bimetal structure. In the bimetal structure, there is a relationship known as a Stoney's equation between a residual stress σ and a curvature radius R in an interface between two layers. When the Stoney's equation is applied to the laminated body of the lower layer portion 11 and the upper layer portion 12, the following relationship (numeral 1) is satisfied.

[Numeral 1]

σ=(Ms×hs²)/(6×hf×R)

Ms=E/(1−ν)

It may be noted that “hs” indicates the thickness of the lower layer portion 11, “hf” indicates the thickness of the upper layer portion 12, “Ms” indicates a biaxial elasticity modulus of the lower layer portion 11, “E” indicates a Young's modulus common to the lower layer portion 11 and the upper layer portion 12, and “ν” indicates a Poisson's ratio common to the lower layer portion 11 and the upper layer portion 12.

If the thickness hs of the lower layer portion 11 and the thickness hf of the upper layer portion 12 are substantially equal and the Poisson's ratio ν is 0.3, the residual stress σ may be represented by the following formula (numeral 2).

[Numeral 2]

σ=(E×hs)/(4.2×R)

Accordingly, when residual stresses obtained from curvature radiuses R₁, R₂ in arbitrary two kinds of temperatures T₁, T₂ are σ₁, σ₂, respectively, a difference Δσ between the residual stresses brought about by a difference ΔT between the temperatures T₁ and T₂ is represented by the following formula (numeral 3).

[Numeral 3]

Δσ=(σ₂−σ₁)=(E×hs)×(R₁−R₂)/(4.2×R₁×R₂)

Further, a residual stress σ is represented by a product of a difference between thermal expansion coefficients and an elasticity modulus. Therefore, when the thermal expansion coefficient of the lower layer portion 11 is α₁ and the thermal expansion coefficient of the upper layer portion 12 is α₂, the difference Δσ between the residual stresses may be also represented by the following formula (numeral 4).

[Numeral 4]

Δσ=E×(α₁−α₂)×ΔT=E×(α₁−α₂)×(T₂−T₁)

Accordingly, the following formula (numeral 5) is led from the formulas presented in the numeral 3 and the numeral 4.

[Numeral 5]

(E×hs)×(R₁−R₂)/(4.2×R₁×R₂)=E×(α₁−α₂)×(T₂−T₁)

Thus, if an actual measured value of a thermal expansion coefficient of the circuit board 1 itself is used as the thermal expansion coefficient α₂ of the upper layer portion 12, the thickness of the lower layer portion 11 may be presented with the actual measured value as in the following formula (numeral 6).

[Numeral 6]

α₂=α₁−((hs×(R₁−R₂))/(4.2×R₁×R₂)×(T₁−T₂)

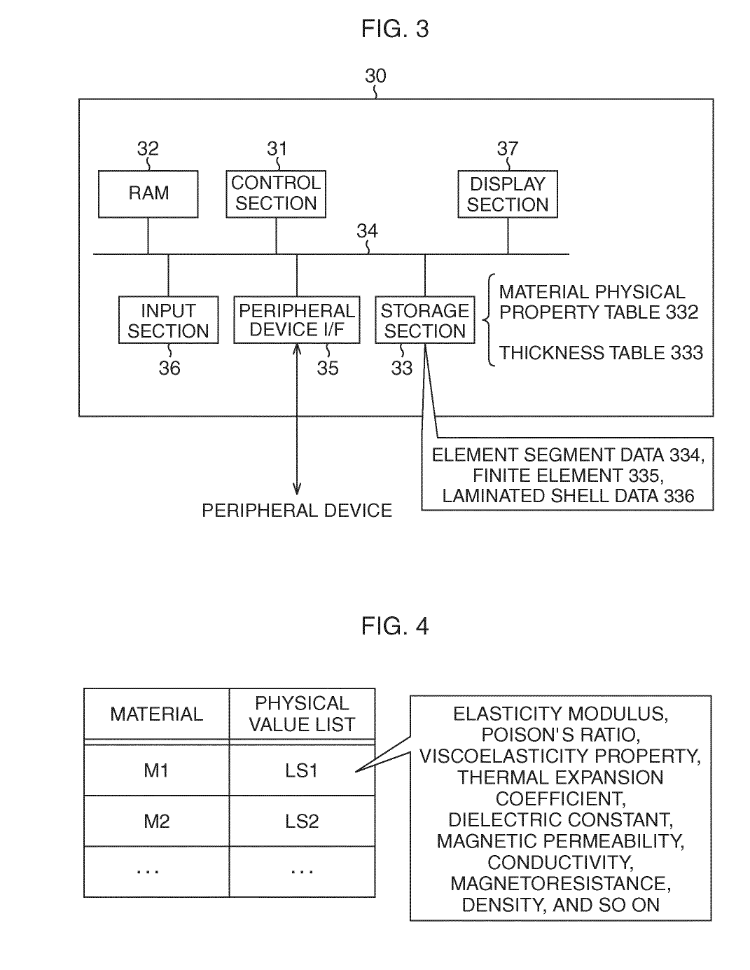

Next, the analysis apparatus is described. FIG. 3 is a block diagram illustrating a configuration of the analysis apparatus according to the embodiment.

An analysis apparatus 30 according to the present embodiment is provided with a control section 31, a RAM (Random Access Memory) 32, a storage section 33, a peripheral device connection interface (peripheral device I/F) 35, an input section 36 into which information is inputted, and a display section 37 which displays information. The control section 31, the RAM 32, the storage section 33, the peripheral device I/F 35, the input section 36, and the display section 37 are connected to each other via a bus 34.

The control section 31 includes a CPU (Central Processing Unit) and executes programs stored in the RAM 32 thereby to control the respective sections included in the analysis apparatus 30.

The RAM 32 functions as a storage device which temporarily stores a computation result in a processing of the analysis apparatus 30 and the programs.

As the storage section 33, a nonvolatile storage medium such as a hard disk, an optical disk, a magnetic disk, or a flash memory, for example, is used, and the storage section 33 stores a variety of data and the programs and the like such as an OS (Operating System) before being stored into the RAM 32. The storage section 33 also stores a material physical property table 332 in which a material contained in the analysis object (circuit board and the like) and its physical property are made to correspond to each other. Further, the storage section 33 also stores a thickness table 333 in which a point specified by two-dimensional coordinates (xy coordinates of FIG. 2) in a surface of the analysis object and a thickness (size in a z-axis direction of FIG. 2) of the analysis object in that point are made to correspond to each other.

The peripheral device I/F 35 is an interface to which a peripheral device is connected. As the peripheral device I/F, there may be cited a parallel port, a USB (Universal Series Bus) port, and a PCI card slot, for example. As the peripheral device, there may be cited a printer, a TV tuner, an SCSI (Small Computer System Interface) apparatus, an audiovisual apparatus, a driving apparatus, a memory card reader/writer, a network interface card, a wireless LAN card, a modem card, a keyboard, a mouse, and a display device, for example. Communication between the peripheral device and the analysis apparatus 30 may be either wired communication or wireless communication.

As the input section 36, an input device, to which an instruction request from a user is inputted, such as a keyboard or a mouse, for example, is used.

As the display section 37, a display device, which presents information to the user, such as a CRT (Cathode Ray Tube) or a liquid crystal display, for example, is used.

As the analysis apparatus 30, a desktop PC, a notebook PC, a PDA (Personal Digital Assistance), or a server, for example, may be used.

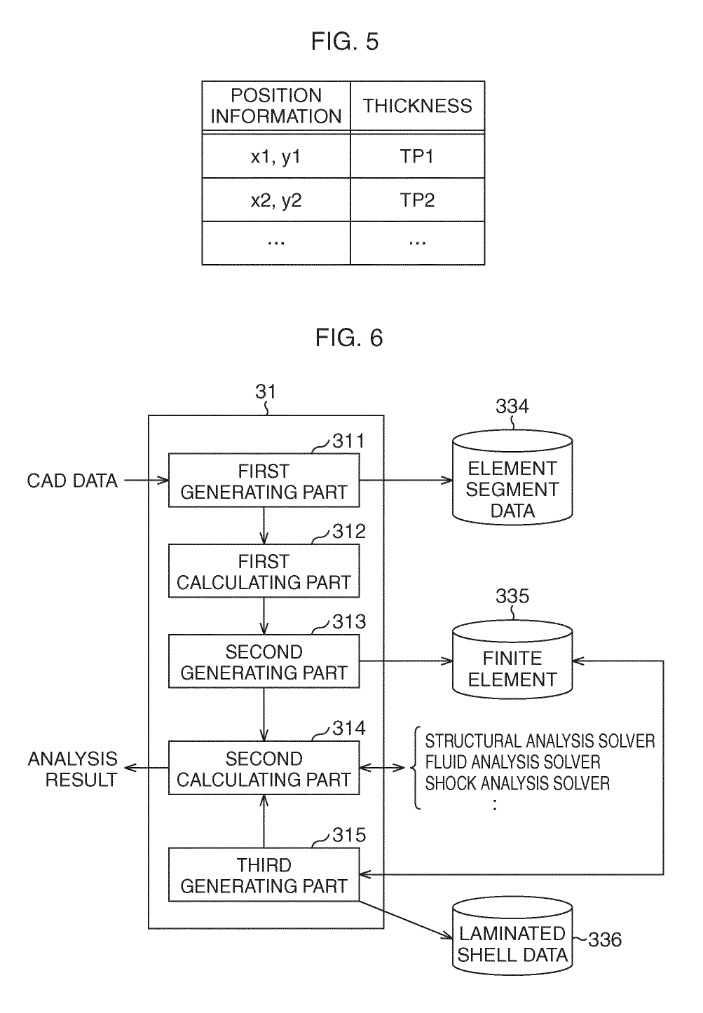

Here, the material physical property table 332 and the thickness table 333 are described. FIG. 4 is a table illustrating an example of a data configuration of the material physical property table 332, and FIG. 5 is a table illustrating an example of a data configuration of the thickness table 333.

The material physical property table 332 is provided with fields of “material” and “physical property value list”, as illustrated in FIG. 4. A name of a material constituting an analysis object, the name being converted into a value or a symbol, is stored in the field of “material”. As the name of the material, there may be cited a conductor, a composite material, and air, for example. An enumeration of property values of the materials stored in the field of “material” is converted into a value or a symbol and stored in the field of “physical property value list”. As the physical property value, there may be cited an elasticity modulus, a Poisson's ratio, a viscoelasticity property, a thermal expansion coefficient, a dielectric constant, a magnetic permeability, a conductivity, a magnetoresistance, and a density, for example. By referring to such a material physical property table 332, when “material” is specified its physical property value may be obtained.

The thickness table 333 is provided with fields of “position information” and “thickness” as illustrated in FIG. 5. Two-dimensional coordinates (xy coordinates of FIG. 2) are stored in the field of “position information” as information to specify a position of a point in a surface of the analysis object. A thickness (size in a z-axis direction of FIG. 2) at a time of a structure analysis in a position stored in the field of “position information”, the thickness being converted into a percentage with a thickness of the analysis object at a design time being 100%, is stored in the field of “thickness”. For example, if the thickness at the design time is 5 mm and “thickness” is 80% in the thickness table 333, the thickness at that point is corrected to 4 mm when being used in the structural analysis. It is possible to designate “thickness” as a length instead of a proportion.

Next, a functional configuration of the analysis apparatus 30 is described. FIG. 6 is a functional block diagram illustrating a configuration of the analysis apparatus 30.

In the control section 31 of the analysis apparatus 30, there are included a first generating part 311, a first calculating part 312, a second generating part 313, a second calculating part 314, and a third generating part 315. The respective parts are constituted by the CPU of the control section 31 and the programs executed by the control section 31 in the present embodiment, but may be constituted by hardware.

The first generating part 311, assuming that the circuit board 1 is the laminated body of the lower layer portion 11 and the upper layer portion 12, sets a thermal expansion coefficient of the circuit board 1 itself, the thermal expansion coefficient having been measured in advance, as the thermal expansion coefficient α₂ of the upper layer portion 12. Further, the first generating part 311 sets a value obtained from the [numeral 6] as the thermal expansion coefficient α₁ of the lower layer portion 11. Then, the laminated body of the lower layer portion 11 and the upper layer portion 12 is segmented into a plurality of grid data, and element segment data 334 in which a position of grid data and a material are made to correspond to each other is generated. The element segment data 334 is stored into the storage section 33 as illustrated in FIG. 3.

The first calculating part 312 defines a plurality of meshes which segment the analysis object by a unit larger than the grid data, and calculates.

The second generating part 313 generates a finite element 335 based on the element segment data 334.

The second calculating part 314 calculates a physical quantity occurring in the analysis object based on the finite element 335 with a solver such as a structural analysis solver, a fluid analysis solver, and a shock analysis solver, thereby to output an analysis result. In other words, the second calculating part 314 performs a simulation of behavior of the analysis object. This simulation is within an arbitrary temperature range set by the user, for example. Further, the second calculating part 314 may also perform a structural analysis based on laminated shell data 336 generated by the third generating part 315.

The third generating part 315 specifies a zone in which the same material is continuous in a thickness direction of the meshes with the same two-dimensional coordinates from the finite element 335, and thereby generates the laminated shell data 336 in which the continuous material and the thickness of the continuous material are made to correspond to the position of the mesh. This laminated shell data 336 is stored into the storage section 33 as illustrated in FIG. 3.

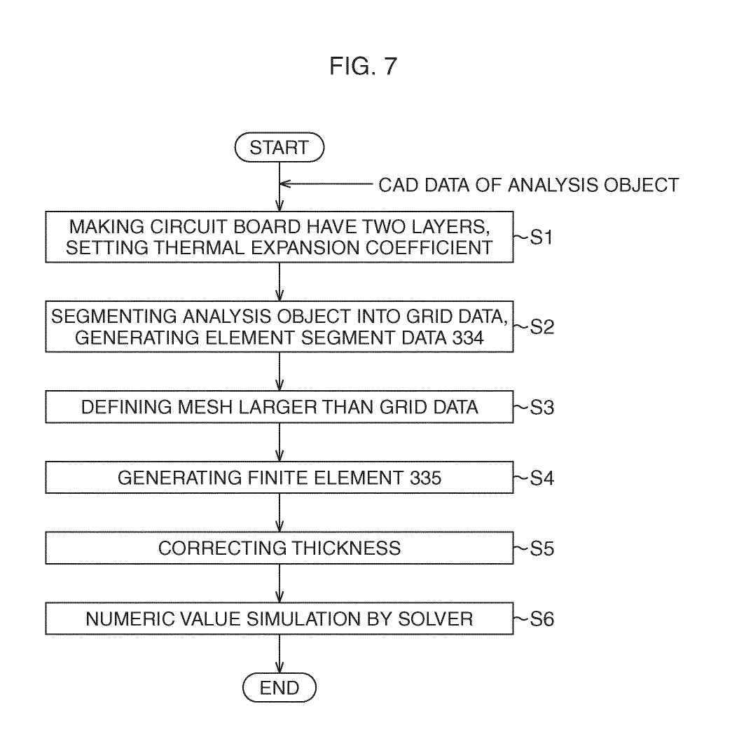

Next, an operation of the analysis apparatus 30 is described. FIG. 7 is a flowchart illustrating the operation of the analysis apparatus 30 according to the embodiment.

First, CAD data to specify a shape of the analysis object is given to the analysis apparatus 30 by the user or the like. Further, a temperature property of a curvature radius obtained from an actual measurement result of a three-dimensional deformation due to a temperature change of the circuit board 1 is also given to the analysis apparatus 30. Thereafter, the first generating part 311 assumes that a circuit board is a laminated body constituted by a lower layer portion 11 and an upper layer portion 12 from the given CAD data, and sets thermal expansion ratios α₁ and α₂ thereof (step S1).

Further, the first generating part 311 segments the analysis object into grid data from the given CAD data, thereby to generate element segment data 334 (step S2). Then, the generated element segment data 334 is stored into the storage section 33.

Once the element segment data 334 is generated (step S2), the first calculating part 312 defines a mesh which segments the analysis object by a unit larger than the grid data segmented by the first generating part 311 (step S3). On this occasion, the first calculating part 312 first sorts the analysis object having been segmented into the grid data by a layer, and grasps a layout in two-dimensional plane (xy coordinates of FIG. 2) of each layer. Next, the first calculating part 312 defines the mesh larger than the grid data so that only one kind of “material” is included in one mesh in that two-dimensional plane.

Next, the second generating part 313 generates a finite element 335 based on the element segment data 334 with the mesh defined by the first calculating part 312.

Once the finite element 335 is generated, the second calculating part 314 performs a correction of a thickness while referring to the thickness table 333 (step S5). Namely, the second calculating part 314 calculates a numeric value made by multiplying a length of an edge of a cube by a proportion specified by “thickness”, as a thickness by the layer.

Next, the second calculating part 314 performs an analysis with a solver program (solving method of a stiffness equation) based on the finite element 335 (step S6). On this occasion, the second calculating part 314 uses the finite element 335 in which the thickness after the correction is reflected, if the thickness is corrected in the step S5. As the solver program, the structural analysis solver, the fluid solver, the shock analysis solver, and so on, for example, may be cited, and a heat conduction analysis, a heat stress analysis, a shock analysis and so on in the analysis object are performed. In particular, in the present embodiment, it is analyzed what stress is generated in the circuit board 1, the electronic component 2, and the solder bump 3 in mounting of the electronic component.

In the present embodiment, it is assumed that the circuit board 1 is a structure in which a warpage occurs when a temperature change occurs, and an actual measurement result of the three-dimensional deformation is reflected in a warpage amount thereof, and thus a highly accurate analysis of a stress may be performed by quite a simple processing. Therefore, when compared with a method in which a mounted structure of an electronic component 2 is added to an analysis element in addition to an analysis of a warpage of a circuit board 1 itself with a wiring pattern of the circuit board 1 being a starting point, an accuracy of the structural analysis is higher and an analysis time may be significantly shortened.

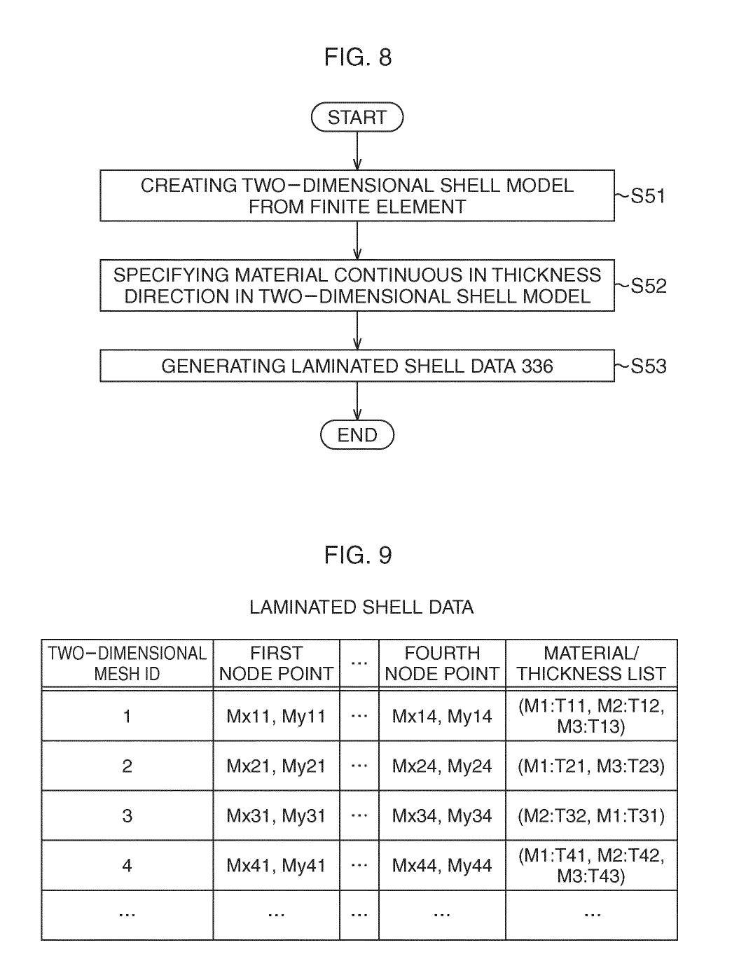

It may be noted that the laminated shell data 336 may be used instead of the finite element 335 in the structural analysis. In this case, the third generating part 315 generates the laminated shell data 336 between the step S3 and the step S4. FIG. 8 is a flowchart illustrating a method of generating the laminated shell data 336.

The third generating part 315 first creates a two-dimensional shell model from the finite element 335 (step S51). The two-dimensional shell model is a model in which a plurality of meshes with the same two-dimensional coordinates from a first node point 71 to a fourth node point 74 in different layers is integrated into one and those meshes are aligned in order from a smaller one in a z coordinate. In other words, the two-dimensional model is a model made by integrating the plural meshes which overlap each other when the respective layers are projected to an xy plane.

Next, the third generating part 315 specifies the material continuous in a thickness direction (z axis direction) in each mesh integrated into the two-dimensional mesh model (step S52).

Then, the third generating part 315 calculates a thickness of each material depending on how many layers each material is continuous in, thereby to generate the laminated shell data 336 (step S53). FIG. 9 is a table illustrating an example of a data configuration of the laminated shell data 336.

The laminated shell data 336 of FIG. 9 includes information regarding “two-dimensional mesh ID”, “first node point” to “fourth node point”, and “material/thickness list”.

“Two-dimensional mesh ID” indicates an identifier to specify the mesh obtained by integrating the plural meshes with the same two-dimensional coordinates into one in the two-dimensional mesh model.

“First node point” to “fourth node point” indicate two-dimensional coordinates to specify each vertex of the mesh specified by the identifier presented in a field of “two-dimensional mesh ID”.

“Material/thickness list” indicates a list in which a name of the material continuous in the thickness direction and its thickness are made a pair. The thickness may be an actual length or the number of the continuous layers. In a case of the latter, when the length of the edge of the cubic being the grid data is known, conversion into the actual length is possible.

It may be noted that, in a case in which the laminated shell data 336 is used in the structural analysis, the second calculating part 314 multiplies, in the step S5, a thickness in “material/thickness list” corresponding to that material by a proportion of “thickness” (see the thickness table 333 of FIG. 5) in a center of that mesh, for a thickness by a material constituting the mesh. For example, with regard to the mesh of which “two-dimensional mesh ID” of FIG. 9 is “1”, if “thickness” in a center of that mesh is set to be 80%, the second calculating part 314 regards a value obtained by multiplying a thickness “T11” corresponding to a material “M1” by 0.8 as a thickness of the material “M1”. Similarly, with regard to other materials “M2” and “M3” included in the mesh whose “two-dimensional mesh ID” is “1”, values obtained by multiplying thicknesses “T12”, “T13” by 0.8 are regarded as thicknesses of the materials “M2” and “M3”.

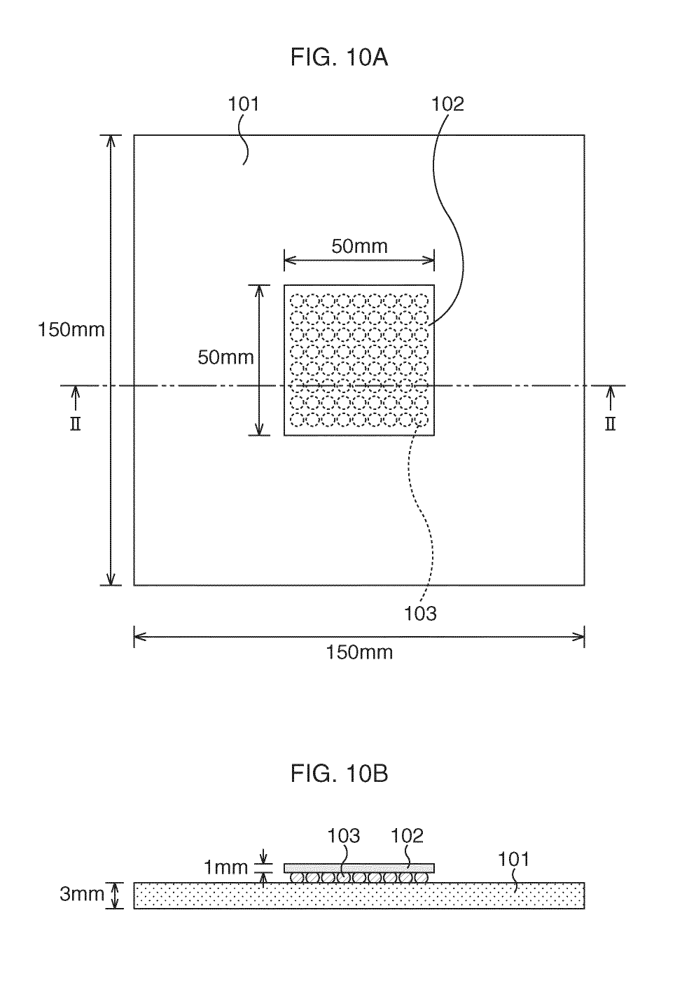

Next, a content and a result of the structural analysis the present inventor actually performed are described. FIG. 10A is a plan view illustrating an analysis object, while FIG. 10B is a cross-sectional view taken along a line II-II in FIG. 10A.

In this analysis, the analysis object illustrated in FIG. 10A and FIG. 10B was used. In this analysis object, an electronic component 102 was mounted onto a circuit board 101 via a solder bump 103. A planer shape of the circuit board 101 was a square whose edge was 150 mm, and a thickness thereof was 3 mm. Further, a planer shape of the electronic component 102 was a square whose edge was 50 mm, and a thickness thereof was 1 mm.

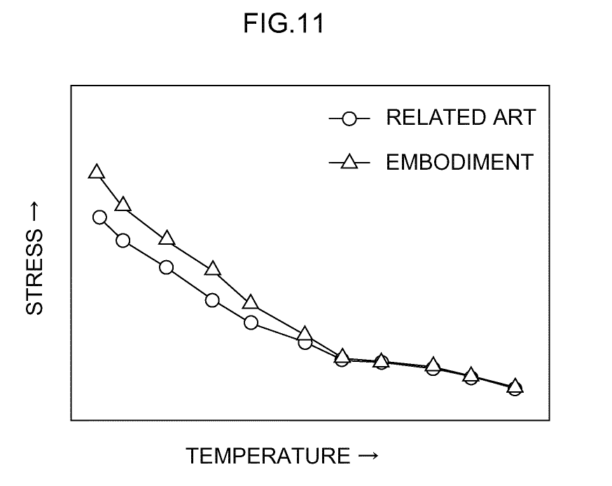

Then, a mounting stress acting on the solder bumps 103 corresponding to four corners of the electronic component 102 at a variety of mounting temperatures was analyzed with the analysis apparatus 30. In this analysis, an analysis of a stress at a predetermined temperature was performed with commercially available structural analysis software (ABAQUAS). Further, a similar analysis was performed also by a conventional technique in which the circuit board 101 was regarded as being made of a single substance. The results thereof are illustrated in FIG. 11.

As illustrated in FIG. 11, there was obtained a result that the mounting stress was larger in the embodiment compared with the conventional technique. Hence, it may be said that, in the embodiment, the three-dimensional deformation of the circuit board 101 corresponding to a temperature change was considered, that the stress by its influence was added, and that a highly accurate structural analysis close to an actual phenomenon was performed.

It may be noted that in the above-described embodiment, though the thermal expansion coefficients of the lower layer portion 11 and the upper layer portion 12 are constant, the thermal expansion coefficient may have temperature dependence. Further, a bump used for connection between a circuit board and an electronic component is not limited to a solder bump.

Further, it is possible to assume that a structure of the circuit board 1 is a laminated body of three or more layers. Further, it is possible to assume that the structure of the circuit board 1 is a structure in which a certain substance is buried in another substance, instead of assuming that the structure of the circuit board 1 is the laminated body. However, if it is assumed that the structure is a complicated one, a calculation amount increases by that amount, and thus it is preferable to assume that the structure is as simple as possible. Further, as at least one of the substances to be assumed to constitute the circuit board 1, it is preferable to use a substance different from a substance which actually constitutes the circuit board 1. This is because if all are regarded as the same as the substances which actually constitute the circuit board 1, a structure obtained by an assumption becomes the same as or similar to the actual structure of the circuit board 1, and a reduction of the calculation amount becomes difficult.

It may be noted that the present embodiment may be realized as a result that a computer or a processer executes a program, for example. Further, a means supplying a program to a computer, a computer readable recording medium such as a CD-ROM in which the program is recorded, for example, or a transmission medium such as Internet which transmits the program may be applied as the present embodiment. Further, the above-described program for printing processing may be applied as the present embodiment. The above-described program, recording medium, transmission medium and program product are included in a range of the present embodiments.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it may be understood that the various changes, substitutions, and alterations could be made hereto without departing from the spirit and scope of the invention.

According to such analysis apparatus and so on, since it is assumed that a circuit board includes two substances with thermal expansion coefficients different from each other, a highly accurate analysis may be performed in consideration of a three-dimensional deformation due to a temperature change. Further, since a structure obtained by this assumption becomes simple, an increase of a calculation amount may be suppressed.

What is claimed is:

1. An analysis apparatus comprising:
an assuming portion configured to assume that a structure of a circuit board includes two substances with thermal expansion coefficients different from each other; and
a simulation portion configured to simulate a mounting stress in mounting an electronic component to the circuit board with a result of an assumption by the assuming portion.

2. The analysis apparatus according to claim 1, wherein the assuming portion assumes that at least one of the two substances is a substance different from a substance actually constituting the circuit board.

3. The analysis apparatus according to claim 1, wherein the assuming portion assumes that the two substances are two layers.

4. The analysis apparatus according to claim 3, wherein the assuming portion assumes that thicknesses of the two layers are substantially equal to each other.

5. The analysis apparatus according to claim 1, wherein the assuming portion assumes that an elasticity modulus of the two substances is substantially equal to an elasticity modulus of the circuit board.

6. The analysis apparatus according to claim 1, wherein the assuming portion assumes that the thermal expansion coefficient of the substance which includes a portion to which the electronic component is mounted is substantially equal to a thermal expansion coefficient of the circuit board.

7. An analysis method comprising:
assuming that a structure of a circuit board includes two substances with thermal expansion coefficients different from each other; and
simulating a mounting stress in mounting an electronic component to the circuit board with a result of an assumption in the assuming.

8. The analysis method according to claim 7, wherein, in the assuming, it is assumed that at least one of the two substances is a substance different from a substance actually constituting the circuit board.

9. The analysis method according to claim 7, wherein, in the assuming, it is assumed that the two substances are two layers.

10. The analysis method according to claim 9, wherein, in the assuming, it is assumed that thicknesses of the two layers are substantially equal to each other.

11. The analysis method according to claim 7, wherein, in the assuming, it is assumed that an elasticity modulus of the two substances is substantially equal to an elasticity modulus of the circuit board.

12. The analysis method according to claim 7, wherein, in the assuming, it is assumed that the thermal expansion coefficient of the substance which includes a portion to which the electronic component is mounted is substantially equal to a thermal expansion coefficient of the circuit board.

13. An analysis program product for causing a computer to perform:
assuming that a structure of a circuit board includes two substances with thermal expansion coefficients different from each other; and
simulating a mounting stress in mounting an electronic component to the circuit board with a result of an assumption in the assuming.

14. The analysis program product according to claim 13, wherein, in the assuming, it is assumed that at least one of the two substances is a substance different from a substance actually constituting the circuit board.

15. The analysis program product according to claim 13, wherein, in the assuming, it is assumed that the two substances are two layers.

16. The analysis program product according to claim 15, wherein, in the assuming, it is assumed that thicknesses of the two layers are substantially equal to each other.

17. The analysis program product according to claim 13, wherein, in the assuming, it is assumed that an elasticity modulus of the two substances is substantially equal to an elasticity modulus of the circuit board.

18. The analysis program product according to claim 13, wherein, in the assuming, it is assumed that the thermal expansion coefficient of the substance which includes a portion to which the electronic component is mounted is substantially equal to a thermal expansion coefficient of the circuit board.
